(19) United States
(12) Patent Application Publication
(10) Pub. No.: US 2004/0044448 A1
(43) Pub. Date: Mar. 4, 2004

(54) Vehicle systems controller with modular architecture

(75) Inventors: Deepa Ramaswamy, Canton, MI (US); Ryan Abraham McGee, Ann Arbor, MI (US)

Correspondence Address: FORD GLOBAL TECHNOLOGIES, LLC., SUITE 600 - PARKLANE TOWERS EAST, ONE PARKLANE BLVD., DEARBORN, MI, 48126, US

(73) Assignee: Ford Motor Company, Dearborn, MI (US)

(21) Appl. No.: 10/064,894

(22) Filed: Aug. 27, 2002

(51) Int. Cl. B60L 11/00

(52) U.S. Cl. 701/22; 180/65.3

(57) ABSTRACT

A hybrid electric vehicle system controller 40. The vehicle system controller 40 is modular and is partitioned in a manner which takes into account a logical grouping of vehicle functions, while maintaining a hierarchy of control within the controller 40.

### BACKGROUND OF THE INVENTION

1. Field of the Invention

This invention relates to a vehicle systems controller having a modular architecture and more particularly, to a vehicle systems controller for use with a hybrid electric vehicle and having a modular architecture which is logically partitioned based upon vehicle functionality, thereby allowing for relatively quick and easy modification or replacement of vehicle control processes or features.

2. Background of the Invention

Vehicle systems controllers (“VSCs”) are devices used within automotive vehicles, such as a hybrid electric vehicle (“HEV”), in order to control various vehicle systems, processes and functions and are often part of the powertrain controller. One type of hybrid electric vehicle, commonly referred to as a “power split” type hybrid electric vehicle, includes three powertrain subsystems which cooperatively provide the torque necessary to power the vehicle, and a vehicle system controller which controls the three subsystems. A “parallel-series” type hybrid electric vehicle includes an engine subsystem (e.g., an internal combustion engine and controller), a generator subsystem (e.g., a motor/generator and controller), and a motor subsystem or an “electric drive subsystem” (e.g., an electric motor and controller).

This hybrid configuration provides improved fuel economy, and reduced emissions since the internal combustion engine can be operated at its most efficient/preferred operating points by use of the various subsystems. Additionally, this configuration can achieve better driveability, and may extend vehicle performance relative to a comparative conventional vehicle. In order to achieve the goal, appropriate coordination and control between subsystems in the HEV are essential. This goal is achieved by use of the VSC and a hierarchical control architecture.

The VSC is typically used to interpret driver inputs (e.g., gear selection, accelerator position and braking effort), to coordinate each of the vehicle subsystems, and to determine the vehicle system operating state. The VSC generates commands to the appropriate subsystems based on driver inputs and control strategies, and sends the generated commands to the respective subsystems. The generated commands sent to the respective subsystems are effective to cause the subsystems to take appropriate actions to meet the driver's demands.

Due to the numerous types of vehicle subsystems and processes which may vary from vehicle to vehicle, conventional VSCs are relatively complex and are designed to serve and/or function within a specific type of vehicle. Due to this complexity and design, it is relatively difficult to modify a conventional VSC to operate with a new vehicle system or functionality. For example and without limitation, if one were to replace the braking system or functionality within an HEV having a conventional VSC with a different type of system of functionality (e.g., series versus parallel regenerative braking), many control features within the powertrain controller would have to be modified or reprogrammed. This increases the cost and time required to make such a modification. Moreover, each different type of HEV typically requires a VSC with a somewhat different functionality, thereby reducing the uniformity among HEVs and increasing the overall cost of the HEVs.

There is therefore a need for a modular VSC which is partitioned into portions which corresponds to and/or provide a logical grouping of vehicle functions, thereby allowing the VSC to be easily modified to conform to new vehicle functions or features.

### SUMMARY OF THE INVENTION

A first non-limiting advantage of the present invention is that the present invention provides a vehicle system controller (“VSC”) for a hybrid electric vehicle (“HEV”) which overcomes at least some of the previously delineated drawbacks of prior VSCs or powertrain controllers.

A second non-limiting advantage of the present invention is that the present invention provides a modular VSC which includes various portions which correspond to a logical grouping of vehicle functions, thereby allowing the vehicle functionality to be relatively easily modified.

A third non-limiting advantage of the present invention is that the present invention provides a VSC that is partitioned to take into account a logical grouping of vehicle functions, while maintaining a hierarchy of control within the VSC.

According to a first aspect of the present invention, a modular vehicle system controller is provided for use with a hybrid electric vehicle. The modular vehicle system controller includes a plurality of portions, wherein each of the plurality of portions corresponds to a certain vehicle functionality.

According to a second aspect of the present invention, a method of organizing a vehicle system controller for use with a hybrid electric vehicle is provided. The method includes the step of partitioning the controller into a plurality of control portions, each of the plurality of control portions corresponding to a particular vehicle functionality.

Further objects, features, and advantages of the invention will become apparent from the following detailed description of the preferred embodiment of the invention and by reference to the following drawings.

### BRIEF DESCRIPTION OF THE DRAWINGS

FIG. 1 is a block diagram of a hybrid electric vehicle which includes a vehicle system controller which is made in accordance with the teachings of a preferred embodiment of the present invention.

FIG. 2 is a block diagram illustrating the vehicle system controller architecture which is utilized within the hybrid electric vehicle shown in FIG. 1.

### DETAILED DESCRIPTION

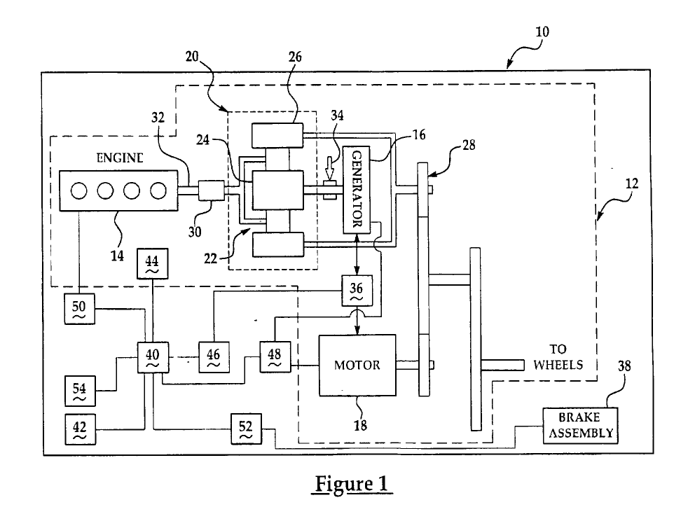

Referring now to FIG. 1, there is shown an automotive hybrid electric vehicle 10 having a powertrain, propulsion or drive system 12 and a modular vehicle system controller 40 which is made in accordance with the teachings of the preferred embodiment of the present invention. As should be appreciated to those of ordinary skill in the art, propulsion system 12 is a “parallel-series” type propulsion system, and includes an internal combustion engine 14, an electric generator/motor 16, and a motor subsystem 18. While the modular vehicle system controller 40 of the preferred embodiment of the invention is described as being used with a power split type HEV, it should be appreciated that the modular controller 40 is capable of controlling various other drive system configurations and methodologies.

The engine 14 and generator 16 are interconnected by use of a conventional planetary gear set 20, including a carrier 22, a sun gear 24 and a ring gear 26, which is operatively coupled to drive line 28. System 12 further includes a conventional one-way clutch 30 which is operatively coupled to the output shaft 32 of engine 14, and a brake or clutch assembly 34 which is operatively coupled to generator 16. A conventional electrical energy storage device 36 (e.g., a battery or other electrical energy storage device) is operatively coupled to generator 16 and motor 18. Battery 36 receives and provides power from/to generator 16 and provides power to/from motor 18.

In the preferred embodiment of the invention, the engine 14 is a conventional internal combustion engine, and is physically and operatively coupled to the carrier 22 of the planetary gear set 20. Generator 16 is a conventional motor/generator and is physically and operatively coupled to the sun gear 24 of the planetary gear set 20. Planetary gear set 20 allows engine 14 and generator 16 to selectively cooperate as a “single power source” which provides a power or torque output from the ring gear 26 of the planetary gear set 20 to the drive line 28. It should be appreciated that planetary gear set 20 further serves as a power split device that splits the output from engine 14 to the generator 16 and to the drive line 28, and as a continuous variable transmission (CVT) between the engine 14 and the ring gear 26, which is operatively coupled to and drives the wheels of vehicle 10.

The electric motor 18 is a conventional electric motor which acts as a “second power source” that provides torque and power to the vehicle drive line 28 independently from the first power source (i.e., engine 14 and generator 16). In this manner, the two power sources (i.e., the internal combustion engine 14 generator 16 and the electric motor 18) can cooperatively deliver torque and power to the vehicle 10 simultaneously and/or independently.

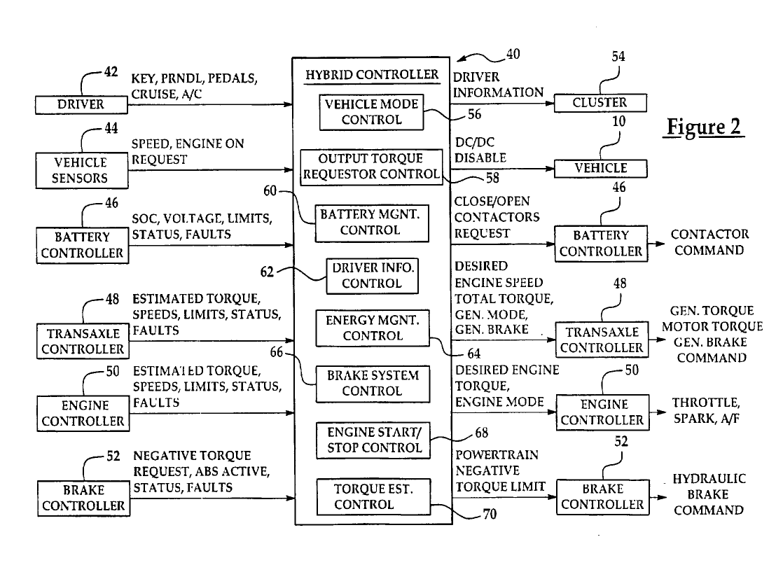

Referring now to FIG. 2; there is illustrated the vehicle system controller 40 which is employed within vehicle 10. In the preferred embodiment of the invention, the vehicle system controller (“VSC”) 40 is electrically and communicatively coupled to conventional user or driver operated controls or components 42, to one or more conventional vehicle operating condition sensors 44, and to subsystem controllers 46-52 by way of a conventional bus or other electrical signal routing assembly. Controller 40 receives signals and/or commands generated by driver inputs, vehicle operating condition sensors (e.g., gear selection, accelerator position, and braking effort), and subsystem controllers (i.e., feedback) and processes and utilizes the received signals to determine the amount of torque which is to be provided to the vehicle's drive train 28 and to generate commands to the appropriate subsystems or controllers 46-52 to selectively provide the desired torque to the drive train 28 and to provide the requisite functionality to vehicle 10.

Each subsystem 46-52 includes or shares one or more microprocessors as well as other chips and integrated circuits which cooperatively control the operation of vehicle 10. In the preferred embodiment, controller 46 comprises a conventional battery controller, controller 48 comprises a conventional transaxle controller for controlling the electric motor 18 and generator 16 (i.e., the electrical components of the transaxle) of vehicle 10, controller 50 comprises a conventional engine controller, and controller 52 comprises a conventional braking controller which includes a conventional friction braking system (e.g., a hydraulically actuated system) and an anti-lock braking system. In the preferred embodiment, VSC 40 shares a microprocessor with at least one of controllers 46-52 (e.g., VSC 40 and engine controller 50 share a microprocessor) in order to reduce cost and decrease packaging size.

VSC 40 receives feedback from each of controllers 46-52 and uses the received feedback along with commands from driver inputs 42 and signals from sensors 44 to generate control commands to the relevant controllers 46-52 and the vehicle's instrument panel or cluster assembly 54. VSC 40 is effective to determine the total amount of torque which is to be provided or delivered to drive train 28 and to partition or divide the total amount of torque between the various subsystems (e.g., divides the torque between the power source, transmission assembly, and braking assembly). The commands, signals and feedback received and provided by VSC 40 are described below.

Driver operated controls 42 provide several commands to VSC 40. Particularly, driver operated controls 42 provide an ignition key command representing the state or position of the ignition key (i.e., OFF, START, RUN, ACCESSORIES), gear shifter commands representing the desired gear engagement of vehicle 10 (i.e., Park, Reverse, Neutral, Drive, and Low or PRNDL), accelerator and brake pedal commands, cruise control commands, and air conditioning commands. Vehicle sensors 44 provide vehicle attribute data to VSC 40, such as vehicle speed data, DC/DC converter operating condition data and other vehicle operating attribute data. Battery controller 46 provides feedback to VSC 40 from battery 36, such as an estimation of the battery's state of charge, battery voltage data, battery limits data, battery operating status data (e.g., recharging), and battery fault data. Transaxle controller 48 provides feedback to VSC 40 from the transaxle (i.e., motor 18 and generator 16), such as estimated torque values provided by motor 18 and generator 16, motor/generator speed values, limits values, motor/generator status data, and motor/generator fault data. Engine controller 50 provides feedback to VSC 40 from engine 14, such as estimated engine-produced torque, engine speed, engine limits data, engine operating status, and engine fault data. Brake controller 52 provides feedback to VSC 40 from the braking assemblies or system 38, such as negative torque request data, anti-lock braking system status and operating data, braking system status data, and braking system fault data.

In the control system architecture, the VSC 40 is the “superior” controller, with subsystems 46 54 (i.e., controllers 46 52 and instrument cluster 54) acting as “subordinate” controllers or assemblies. Exceptions may exist to allow one or more of subsystems 46 54 to override a command from VSC 40 with a “peer” subsystem command (e.g., a command from another of subsystems 46 54) under certain predetermined conditions. In such instances, each subsystem 46 54 communicates with the VSC 40 to inform the VSC 40 of the actual action undertaken which deviates from the VSC commanded action. Each subsystem 46 54 further communicates a signal to VSC 40 when one or more faults are detected in the respective subsystem 46 54, thereby notifying VSC 40 that a fault condition is present. Fault conditions, in another non-limiting embodiment, may also be communicated to a driver of vehicle 10 through instrument cluster assembly 54.

As shown in FIG. 2, the VSC 40 is modular and is composed of different control portions 56-70 which correspond to certain vehicle functions or features. Each portion may represent a removable hardware and/or software segment, portion or device of the VSC 40 which is electrically and/or communicatively interconnected with the other portions of VSC 40. The partitioning of the vehicle features within the VSC 40 provides a logical grouping of functions and also takes into account the hierarchy of control within the VSC 40. The architecture of VSC 40 also enables relatively easy replacement of one type of functionality for another (e.g., series versus parallel regenerative braking). Particularly, a certain vehicle functionality may be replaced by removing (e.g., disconnecting or deleting) a certain portion of controller 40 and installing (e.g., connecting or loading) a replacement portion which provides the desired functionality.

In the preferred embodiment of the invention, control portion 56 provides a vehicle mode control process; control portion 58 provides an output torque requestor control process; control portion 60 provides a battery management control process; control portion 62 provides a driver information control process; control portion 64 provides an energy management control process; control portion 66 provides a brake system control process; control portion 68 provides an engine start/stop control process and control portion 70 provides a torque estimation control process.

Vehicle mode control portion 56 determines the operating mode for the VSC 40. Portion 56 comprises the “top layer” controller for complete powertrain control. Portion 56 communicates the operating mode of the vehicle, as determined by the ignition key position (e.g., OFF, RUN, START, ACCESSORIES), to the other control processes or portions 58-70, that the other portions 58-70 may function according to the current vehicle mode. Portion 56 further checks each system 46-52 for faults prior to starting and stopping the vehicle 10 and during vehicle 10 operation. In providing these functions, portion 56 checks to make sure the other processes 58-70 respond to its commands before proceeding. When a fault is detected within any of the vehicle components (e.g., within the engine 14, generator 16, traction motor 18, or battery 36) portion 56 either selects a limited operating strategy (“LOS”) mode with which to operate the remaining functional powertrain components or shuts down the vehicle 10.

Output torque requestor control portion 58 receives and handles all torque commands from requesting devices within the vehicle 10 (e.g., accelerator pedal, brake pedal, cruise control system, traction control system), and determines the final wheel torque (positive or negative) that the powertrain and regenerative braking system must produce. In order to provide this determination, portion 58 combines the driver demands from the accelerator and brake pedal, and arbitrates from other “torque requesters” such as cruise control, traction control (if program required), interactive vehicle dynamics, and vehicle speed limiting systems. Based upon the signals received from all requestors, portion 58 divides or partitions the total requested torque between the vehicle's powertrain (i.e., engine 14 and motor 18) and brake assemblies 38 and issues corresponding commands to the engine controller 50, transaxle controller 48 and brake controller 52.

Battery management control portion 60 interfaces with the battery controller 46 and controls the opening and closing of the contactors in the battery pack 36, based upon the vehicle mode signals received from portion 56. Portion 60 also reads and processes discharge/charge power limits from the battery controller 46, monitors the battery 36 for faults and communicates this information to the other VSC 40 control portions 56, 58, and 62 70.

Driver information control portion 62 receives signals from the vehicle sensors 44 and controllers 46-52 and calculates vehicle operating data that is conveyed to the driver. Particularly, portion 62 receives measured data from sensors 44, calculates values for vehicle operating conditions (e.g., vehicle speed, battery state of charge, available battery power, and other values) by use of conventional algorithms, and communicates signals representing these values to the instrument panel or cluster 54, and to other vehicle displays or data providing devices.

Energy management control portion 64 controls the power flow between the engine 14, motor 18, generator 16, battery 36, and the wheels. Portion 64 aims to meet the driver needs of power, security and climate control, the program requirements of meeting or exceeding fuel economy, emissions, performance and driveability targets and component requirements such as the maintenance of the battery state of charge within a certain range. The above requirements are met within the constraints imposed by the various components, such as the battery 36, the transaxle, the regenerative braking system, the engine 14, the cooling system, the fuel system and the exhaust system. Portion 64 also processes system faults and based on the LOS mode, portion 64 takes appropriate action to modify the powertrain operating mode (e.g., electric versus hybrid) and the operating point (e.g., desired engine torque and speed).

Brake system control portion 66 implements the regenerative braking control process of the VSC 40 (whether it be for series regenerative braking or for parallel regenerative braking). Portion 66 may also control the components (i.e., engine 14, output shaft 32, planetary gear set 20, and drive train 28) to utilize engine compression braking when regenerative braking is not available.

Engine start/stop control portion 68 coordinates the timing and operation of the “startup” and “shutdown” of the vehicle's engine 14. Portion 68 contains the logical condition used to decide whether to turn on/off the engine 14 or, if already “on”, whether to keep engine 14 “running”. Portion 68 also coordinates the process of engine startup among the engine controller 50 and the transaxle controller 48 in order to minimize undesirable noise, vibrations, “harshness”, and emissions.

Torque estimation control portion 70 estimates the torque produced by the engine 14 and the transaxle (i.e., motor 18 and generator 16). Portion 70 receives torque estimates from the engine controller 50 and transaxle controller 48, and compares the engine controller 50 estimate to the transaxle controller 48 estimate to ensure these estimates are similar. If the estimates vary beyond a certain threshold value, portion 70 notifies portion 56 of a potential fault condition.

In operation, VSC 40 receives commands from driver controls 42, signals from sensors 44 and feedback from controllers 46-52. Particularly, controller 40 receives signals and/or commands generated by driver inputs, vehicle operating condition sensors (e.g., gear selection, accelerator position, and braking effort), and subsystem controllers (i.e., feedback) and processes and utilizes the received signals to determine the amount of torque which is to be provided to the vehicle's drive train 28 and to generate commands to the appropriate subsystems or controllers 46-52 which selectively provide the desired torque to the drive train 28 and to provide the requisite functionality to vehicle 10. Each portion 56-70 of the VSC 40 performs a unique vehicle function as set forth above. This unique arrangement allows for the vehicle components and processes to be easily switched or replaced, without requiring a reprogramming or replacement of the entire controller. This allows modifications to vehicle 10 to be performed relatively quickly, and also allows this VSC 40 to be used on various types of vehicles with portions 56-70 being selected and/or adjusted based upon the particular vehicle's functionality.

It is understood that the invention is not limited by the exact construction or method illustrated and described above, but that various changes and/or modifications may be made without departing from the spirit and/or the scope of the inventions.

1. A modular vehicle system controller for use with a hybrid electric vehicle, said controller comprising a plurality of portions, wherein each of said plurality of portions corresponds to a certain vehicle functionality.

2. The modular vehicle system controller of claim 1 wherein said plurality of portions includes a vehicle mode control portion which is effective to select an operating mode of said vehicle.

3. The modular vehicle system controller of claim 2 wherein said plurality of portions further includes an output torque requester control portion which is effective to receive torque commands from a plurality of vehicle subsystems and to determine a total output torque.

4. The modular vehicle system controller of claim 3 wherein said hybrid electric vehicle includes a battery pack and wherein said plurality of control portions further includes a battery management control portion which is effective to control opening and closing of contactors within the battery pack, monitor the battery pack for faults, and process the battery pack power limits.

5. The modular vehicle system controller of claim 4 wherein said plurality of control portions further includes a driver information control portion which is effective to receive signals from vehicle sensors and to calculate vehicle operating data which is conveyed to a driver of said vehicle.

6. The modular vehicle system controller of claim 5 wherein said hybrid electric vehicle includes at least one power source, and wherein said plurality of control portions further includes an energy management control portion which is effective to control the delivery of power to said vehicle by said at least one power source.

7. The modular vehicle system controller of claim 6 wherein said plurality of control portions further comprises a brake system control portion which controls regenerative and engine compression braking functions within said vehicle.

8. The modular vehicle system controller of claim 7 wherein said plurality of control portions further comprises a torque estimation control portion which estimates an amount of torque produced by said at least one power source.

9. The modular vehicle system controller of claim 8 wherein said at least one power source comprises an internal combustion engine.

10. The modular vehicle system controller of claim 9 wherein said plurality of control portions further comprises an engine control portion which controls a process and timing of when to startup and shutdown said internal combustion engine.

11. A method of organizing a vehicle system controller for use with a hybrid electric vehicle, said method comprising the step of:
partitioning said controller into a plurality of removable control portions, each of said plurality of control portions corresponding to a particular vehicle functionality.

12. The method of claim 11 wherein said step of partitioning said controller into a plurality of removable control portions, each of said plurality of control portions corresponding to a particular vehicle functionality further comprises the step of:
logically grouping said plurality of control portions into functional groups.

13. The method of claim 11 wherein each of said plurality of control portions represents a removable hardware portion.

14. The method of claim 11 wherein each of said plurality of control portions represents a removable software portion.

15. A method of controlling a plurality of systems within a hybrid electric vehicle, said method comprising the steps of:
logically grouping said plurality of systems into functional groups;
providing a vehicle system controller having a modular architecture;
providing a plurality of modular system control portions corresponding to each of said functional groups; and
selectively coupling said plurality of modular system control portions to said vehicle system controller.

16. The method of claim 15 wherein each of said plurality of modular control portions represents a removable hardware portion.

17. The method of claim 15 wherein each of said plurality of modular control portions represents a removable software portion.

18. The method of claim 15 wherein said step of logically grouping said plurality of systems into functional groups further comprises the step of:
maintaining a hierarchical control architecture for said plurality of systems.
